(19) United States
(12) Patent Application Publication
(10) Pub. No.: US 2008/0172900 A1
(43) Pub. Date: Jul. 24, 2008

(54) HALOGEN HAIR DRYER

(76) Inventor: Carlos Jose Ceva, Buenos Aires (AR)

Correspondence Address: HUGHES HUBBARD & REED LLP, ONE BATTERY PARK PLAZA, NEW YORK, NY, 10004, US

(21) Appl. No.: 11/624,858

(22) Filed: Jan. 19, 2007

(51) Int. Cl. A45D 20/08; F26B 3/34

(52) U.S. Cl. 34/96; 34/266

(57) ABSTRACT

A halogen hair dryer, which is characterized in that the halogen tube with “U” form, provided with a carbon filament, is mounted within the spaces in dihedral angle opposed by the central vertex and delimited by both of the orthogonally crossed plates which exist in the holder made of non-flammable dielectric material which houses the heating resistor; said halogen tube is arranged so that its arms are parallel to the central axis of the holder and are placed under the spiral layer that forms the heating resistor wound around the notched edges of the holder.

### BACKGROUND OF THE INVENTION

1. Field of the Invention

The present invention relates generally to devices used at the hairdresser's salon, and it particularly refers to a halogen hair dryer.

2. Description of Prior Art

Within the prior art there are several patents that refer to heating devices which are similar to the one used for the present invention; among them, there have been found no interferences with the object described herein. The following ones have been selected as example:

Patent WO 2006/081223, which relates to a “Method of manufacturing tin oxide-based ceramic resistors and obtained resistors”. There, it is explained how different steps are followed in the process of forming antimony powder with a dose of tin oxide and mixed with a pulverulent vitrifiable compound, and making the resistor by thermal treatment.

Patent U.S. Pat. No. 4,804,823 which consists in a “Ceramic heater”. The heat generator is a resistor placed inside or over the surface of a ceramic holder, with terminals connected at both ends of the resistor. The ceramic substrate is made of certain nitrite selected from the group Si and Al, while the resistor is made of nitrite from Ti (TiN) and Tungsten Carbonate (WC).

Patent U.S. Pat. No. 4,697,165 which describes a ceramic heater and the method of manufacturing it. It is about a heating plate-like ceramic substrate with specific characteristics as regards both its construction and its resistor. It also includes an oxygen sensor and a solid electrolyte for conducting ions, oxygen and electrodes for its measuring.

However, considering the existent background, it arises that each of the analyzed patents has its own and special characteristics aimed to fulfill its objectives, resulting no interference whatsoever with the present invention.

### BRIEF SUMMARY OF THE INVENTION

The present invention is intended to obtain a very simple and economical arrangement to be applied to the construction of the above-mentioned electric hair dryers, simultaneously providing a controlled flow of hot air as well as the radiation produced by a halogen tube fitted to the dryer.

A further object of this invention is to provide an arrangement conceived for the aforementioned purpose, which allows the supply of ultraviolet radiation during the drying of hair performed by the dryer described.

Another object of this invention is to provide a new type of construction, which is extremely simple, so that it can optimally fulfill its purpose: the tube which is filled with a halogen gas, also works as a heater because it has been provided with a carbon filament, which using the same electricity consumption emits more thermal energy.

Another advantage of the present invention is that it has been developed with very economical characteristics which provides the user with the benefit of releasing a focused controlled flow of ultraviolet rays over the scalp that produces vitamin D in the skin.

It also offers a possibility that essentially results in an important advantage and consists in that the far-infrared radiation existent in the thermal emission provided by the special heater included in the device, to which the one provided by the halogen tube is added, is complemented with the soft and controlled emission of ultraviolet radiation provided by said halogen unit.

It is known that vitamin D takes part in Ca and pH absorption which are good for the human body, when they are incorporated into the teeth and bones.

Apart from certain food that incorporate it into the body, the sun, through its ultraviolet rays, makes its synthesis and turns skin ergosterol into vitamin D, thus strengthening the immune system as well as preventing osteoporosis and osteomalacia.

As it is known, the electromagnetic radiation spectrum that surrounds us is basically identified by its wavelength and its frequency. The wavelength λ(m) can be calculated with formula and that is equal to the ratio of the speed of light c in a vacuum (300,000 km/s) divided by the frequency f(Hz).

For this case, it is reminded that infrared rays and ultraviolet rays originate in the opposite sides of the radiation produced by the visible light:

Visible light frequency=3.8×10¹⁴−7.8×10¹⁴ Hz

Near-infrared frequency=1.2×10¹²−3.8×10¹⁴ Hz

Far-infrared frequency=3.0×10¹²−6.0×10¹² Hz

Near-ultraviolet frequency=7.8×10¹⁴−1.5×10¹⁵ Hz

Extreme-ultraviolet frequency=1.5×10¹⁵−3.0×10¹⁶ Hz.

The preferred embodiment of the invention will be more clearly understood by reference to the following detailed description and attached drawings. Various modifications to the components will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 illustrates a perspective view of the heating element holder with the halogen tube placed in position. The resistor has been removed in order to allow a better view of the arrangement.

FIG. 2 is a perspective view illustrating the thermal unit provided with the halogen lamp.

FIG. 3 is a lateral view illustrative of the constructive arrangement of the invention.

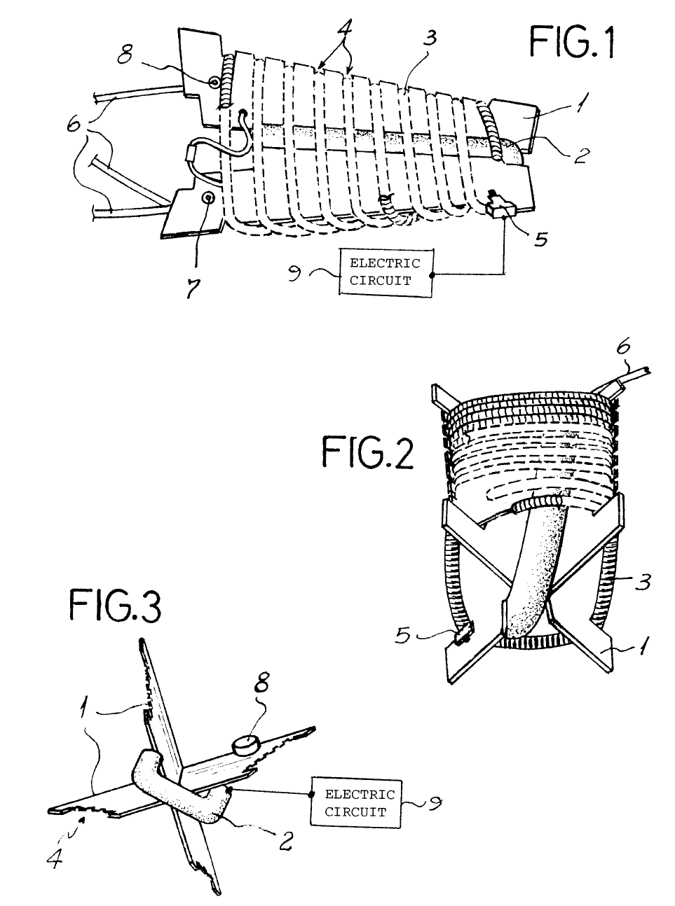

Corresponding reference characters indicate corresponding parts throughout the several views.

### DETAILED DESCRIPTION OF THE INVENTION

According to the attached drawings, the heater with the halogen arrangement comprises a holder made of non-flammable dielectric material 1, which consists of a pair of orthogonally crossed plates; between them, there is a heating tube made of halogen material 2 in “U” form that has a carbon filament (which is not visible in the drawings).

The figures illustrate how each of the halogen “U” tube sides are mounted on one of the holder ends 1, within the spaces opposed by the central vertex and delimited by the dihedral angles formed by both of the holder plates 1.

The wire spiral that forms the resistor 3 is wound around the edges of the crossed plates 1, using the notches 4 made on the plate edges 1 for better distribution. The midpoint of the resistor is connected to the terminal end 5 while the connections 6 of the electric circuit and of the branch connected to said terminal 5, start at the stapled connections 7 converging at the terminal 8 placed at the opposite end of the plates 1.

### Operation

Once the different components of the invention have been explained, there follow further descriptions adding the functional and operational relation between its parts and its outcome.

The operational relation is very simple. As it usually happens with this type of personal or professional devices, the desired temperature for the air released by the dryer is obtained by inserting, within the conventional circuit of the appliance, a part or the whole of the resistance, using the branch 5 aimed for the heating resistor 3.

The halogen tube 2 can also be inserted as heating element. If it is connected alone, the heat emission of its carbon filament will be too soft compared with the one of the heating resistor.

Apart from that, the switch of the halogen lamp can be regulated at user's will according to the time during which the ultraviolet radiation must be applied.

If it is only desired to keep the halogen tube as permanent thermal aid or reinforcement, a UV radiation filter can be inserted.

Thus there has been described one of the possibilities of construction that leads to carry out the invention as well as the way it works, and also its specific application.

1. Halogen hair dryer, consisting of a heating element arranged around a holder formed by a pair of plates assembled in cross form, having numerous notches on its edges for housing a resistor wound around as a spiral, characterized in that a halogen tube with “U” form, provided with a carbon filament, is mounted within the spaces in dihedral angle opposed by a central vertex and delimited by both of the pair of plates which exist in the said holder made of non-flammable dielectric material and housing a heating resistor; said halogen tube is arranged so that its arms are parallel to the central axis of the holder and are placed under the spiral layer that forms the heating resistor wound around the notched edges of the holder.

2. Halogen hair dryer, according to claim 1, characterized in that said halogen tube is independently connected within an electric circuit.

3. Halogen hair dryer, according to claim 1, characterized in that said heating resistor defined by a proper wire spiral, has its midpoint connected to a terminal, from where it connects to an electric circuit.

4. Halogen hair dryer, according to claim 1, characterized in that said heating resistor has its ends fixed in terminals stapled at one end of said holder plates.
